(19) United States
(12) Patent Application Publication
(10) Pub. No.: US 2005/0153746 A1
(43) Pub. Date: Jul. 14, 2005

(54) Mobile terminal capable of editing images and image editing method using same

(75) Inventor: Lee-Seok Yoon, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/916,897

(22) Filed: Aug. 12, 2004

(30) Foreign Application Priority Data
Jan. 13, 2004 (KR) 2241/2004

(51) Int. Cl. H04M 1/00

(52) U.S. Cl. 455/566; 455/550.1

(57) ABSTRACT

A mobile terminal including an image display area and a state display area. The mobile terminal further includes a storing section for storing at least one image and a list of image files; an image editing section for editing an image; and a control section for displaying one of stored images in whole on the state display area and a browsing curser movable over a predetermined area of the image displayed on the state display area, enlarging a portion confined by the browsing cursor to display the portion on an image display area.

### PRIORITY

This application claims priority to an application entitled “Mobile Terminal Capable of Editing Images and Image Editing Method Using Same” filed in the Korean Intellectual Property Office on Jan. 13, 2004 and assigned Serial No. 2004-2241, the contents of which are hereby incorporated by reference.

### BACKGROUND OF THE INVENTION

1. Field of the Invention

The present invention relates generally to a mobile terminal including a camera (i.e., a camera phone), and more particularly to a mobile terminal capable of editing photographed or stored images of varying sizes.

2. Description of the Related Art

Mobile terminals refer to handheld devices capable of performing wireless communication with a base station and providing wireless communication services to users. Such mobile terminals have been widely supplied and become popular worldwide as a necessity among people of different sexes and ages. A mobile terminal essentially comprises a transceiver for transmitting and receiving voice or image data, a data input/output section, and an antenna.

Recently, mobile terminals including an embedded camera have rapidly become popular. Users can take pictures using these mobile terminals and store or send them to another mobile terminal through a wired or wireless communication network. Such mobile terminals can also display images of varying pixel sizes.

Generally, mobile terminals store images in a 640×480 VGA (Video Graphics Array) format. However, when a user sends a large capacity image via e-mail or sets the image as the wallpaper on his or her mobile terminal, the large image may cause delay in operation of the mobile terminal.

Further, although an image having a size larger than 640×480 VGA can be stored in a mobile terminal, it should be scaled down to a size corresponding to the limited display screen size of the mobile terminal in order to be displayed as a wallpaper image. Accordingly, the mobile terminal extracts pixels in an image larger than the display screen and displays the pixel values on the display screen. Because an image larger than the screen size is scaled down to be displayed as a whole, the user may not be able to closely see certain parts or details of the displayed image.

Also, conventional mobile terminals do not have the ability to edit images or store any edited images. Therefore, it is impossible to set a particular part of an image (for example, face part in a photograph of a person) as wallpaper on these conventional mobile terminals.

FIG. 1 is a flow chart illustrating a process of scaling down and displaying an image on the display screen of a conventional mobile terminal. It is assumed that a photographed image is 352×288 pixels in size and that the display screen is 176×144 pixels.

Referring to FIG. 1, the mobile terminal takes a picture using an embedded camera module according to a corresponding signal input in step S12. When a signal to store is input, the mobile terminal encodes the photographed picture image and stores it in a JPEG (Joint Photographic Experts Group) format in step S14.

When a command to display the stored image is input, the mobile terminal decodes the stored image data in step S16. At this time, the mobile terminal stores the decoded data in a buffer in step S18.

Upon preparation to display the image, the mobile terminal outputs the decoded data stored in the buffer to the display screen in step S20. At this time, the mobile terminal converts the decoded image data to a size corresponding to the display screen size and displays the converted image data.

FIG. 2 illustrates an example of an image displayed after size conversion in a conventional mobile terminal. More specifically, FIG. 2 illustrates an image with 325×288 pixels as an example of image data stored in the mobile terminal. The display screen 20 of the mobile terminal consists of an image display area 24 for displaying an image and operational information of the mobile terminal, and a state display area 26 for displaying time information and operational state of the mobile terminal. The image display area 24 has a size of 176×144 pixels.

Accordingly, the mobile terminal must scale down the image data of 325×288 pixels to display it on the image display area 24 of 176×144 pixels. Therefore, the image finally displayed on the image display area 24 has lower image quality than the original image 10.

Further, the user cannot select a particular part of a whole image to separately store or edit the selected part in the conventional mobile terminal.

### SUMMARY OF THE INVENTION

Accordingly, the present invention has been designed to solve the above and other problems occurring in the prior art, and one object of the present invention is to provide a mobile terminal capable of editing images and an image editing method using the same.

Another object of the present invention is to provide a mobile terminal including an image editing function for enabling a user to select a particular part of an image and store or delete the selected part, and an image editing method using the same.

In order to accomplish the above and other objects of the present invention, there is provided a mobile terminal including an image display area and a state display area, said terminal comprising: a storing section for storing at least one image and a list of image files; an image editing section for editing an image; a key input section for inputting a command to edit an image or store the edited image; and a control section for displaying one of stored images in whole on the state display area and a browsing curser movable over a predetermined area of the image displayed on the state display area, enlarging a portion confined by the browsing cursor to display the portion on an image display area, and when a command to store is input, converting the portion displayed on the image display area to a desired size through the image editing section and storing the portion of the image in the storing section.

According to another aspect of the present invention, there is provided a method for editing an image using a mobile terminal including a display screen having an image display area and a state display area, said method comprising the steps of: when a command to edit an image is input, displaying the image in whole on the state display area and a browsing curser movable over a predetermined area of the image displayed on the state display area, and enlarging a portion confined by the browsing cursor to display the portion on the image display area; and when a command to store is input, storing the portion displayed on the image display area.

According to another aspect of the present invention, there is also provided a mobile terminal comprising: a storing section for storing at least one image and a list of image files; an image editing section for editing an image; a key input section for inputting a command to edit an image or store the edited image; and a control section for displaying one of stored images on a display area and a browsing curser having a predetermined size and movable over a predetermined area of the image displayed on the display area, and when a command to store is input, converting a portion confined by the browsing cursor to a desired size through the image editing section and storing the portion of the image in the storing section.

According to another aspect of the present invention, there is also provided a method for editing an image using a mobile terminal, which comprises the steps of: when a command to edit an image is input, displaying the corresponding image on a display area and a browsing curser having a predetermined size and movable over a predetermined area of the image displayed on the display area; and when a command to store is input, converting a portion confined by the browsing cursor and displayed on an image display area to a desired size through the image editing section and storing the portion displayed on the image display area.

### BRIEF DESCRIPTION OF THE DRAWINGS

The above and other objects, features, and advantages of the present invention will be more apparent from the following detailed description taken in conjunction with the accompanying drawings, in which:

FIG. 1 is a flow chart illustrating a process of scaling down and displaying an image on the display screen of a conventional mobile terminal;

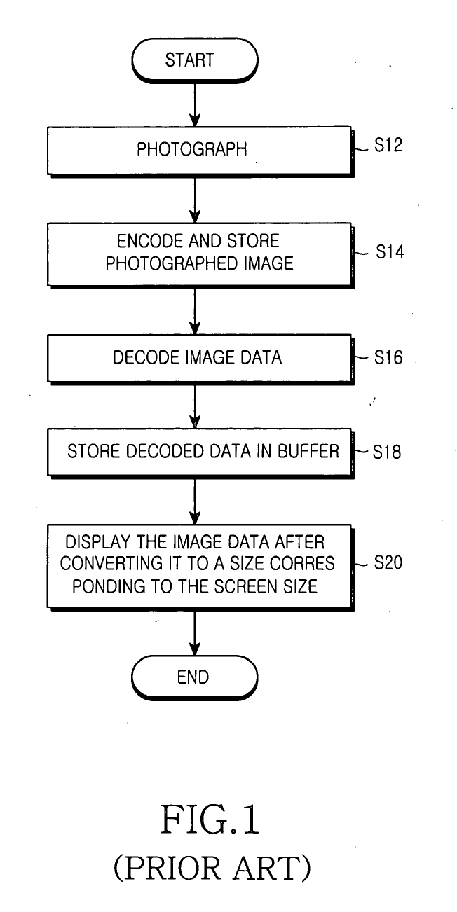

FIG. 2 illustrates an example of an image displayed after size conversion in a conventional mobile terminal;

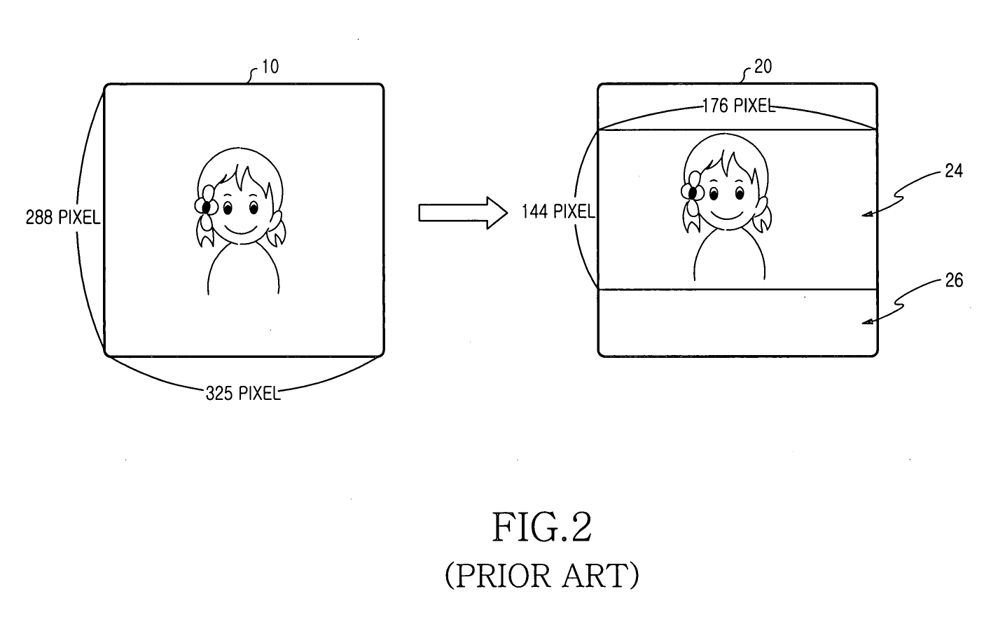

FIG. 3 is a block diagram illustrating a mobile terminal capable of editing an image according to a preferred embodiment of the present invention;

FIG. 4 illustrates a change of an image displayed on the mobile terminal in FIG. 3 when a command to display the whole image is input;

FIG. 5 illustrates a change of an image displayed on the mobile terminal according to the movement of the browsing cursor in FIG. 4;

FIG. 6 illustrates a change of an image selected using the browsing cursor and displayed as a wallpaper image of the mobile terminal; and

FIG. 7 is a flow chart illustrating a process of editing an image using a mobile terminal according to the preferred embodiment of the present invention.

### DETAILED DESCRIPTION OF THE PREFERRED EMBODIMENT

Preferred embodiments of the present invention will be described in detail herein below with reference to the accompanying drawings. In the drawings, the same element, although depicted in different drawings, will be designated by the same reference numeral or character. Although certain elements, such as a circuit device, are specifically defined in the following description of the present invention, it will be obvious to those skilled in the art that such definitions of elements are merely to improve understanding of the present invention and that the present invention is not limited to such specific elements. Also, in the following description of the present invention, a detailed description of known functions and configurations incorporated herein will be omitted when it may make the subject matter of the present invention rather unclear.

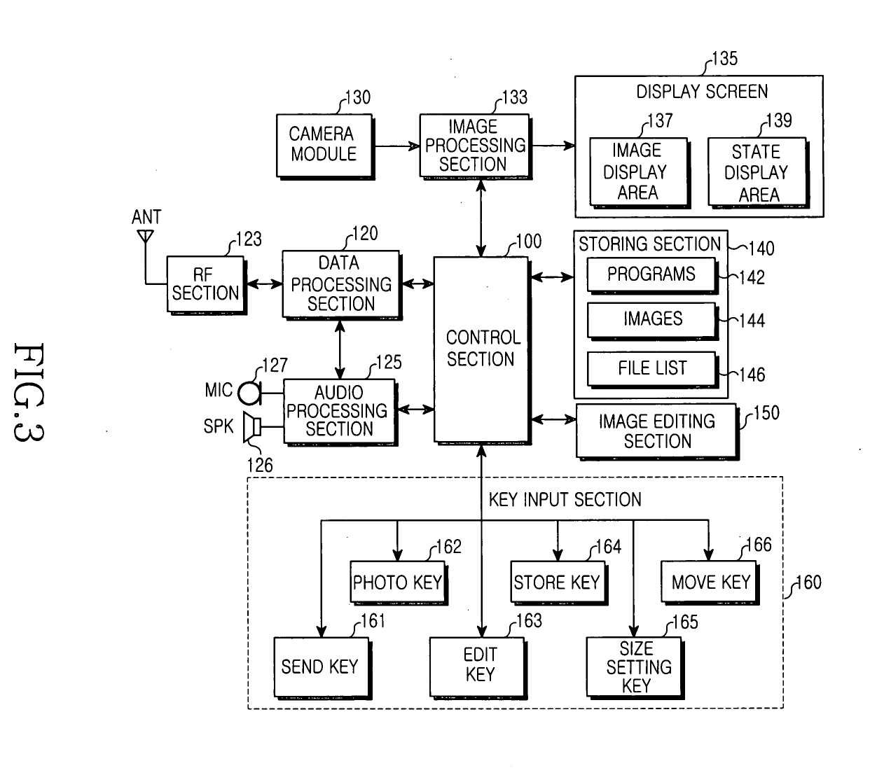

FIG. 3 is a block diagram illustrating a mobile terminal capable of editing an image according to the present invention. Referring to FIG. 3, an RF (Radio Frequency) section 123 performs a wireless communication function of the mobile terminal. The RF section 123 comprises an RF transmitter for performing upward conversion and amplification of the frequency of a signal being transmitted, and an RF receiver for amplifying a signal being received with low noise and performing downward conversion of the frequency of the signal.

A data processing section 120, such as a codec, codes a signal being transmitted from the RF section 123 and decodes a signal being received by the RF section 123. The codec comprises a data codec for processing packet data and an audio codec for processing an audio signal.

An audio processing section 125 reproduces an audio signal output from the data processing section 120 and outputs the reproduced signal to a speaker 126. Also, the audio processing section 125 transmits an audio signal input from a microphone 127 to the data processing section 120.

A camera module 130 is used to take pictures of an object. The camera module 130 comprises a camera sensor for converting a photographed optical signal into an electric signal and a signal processor for converting an analog image signal photographed by the camera sensor into digital data. Supposing that the camera sensor is a CCD (charge coupled device) sensor or a CMOS (complementary metal-oxide-semiconductor), the signal processor can be a DSP (digital signal processor). The camera sensor and the signal processor can be either integrated into a single element or separated as independent elements.

An image processing section 133 generates display data for displaying an image signal (an image) output from the camera module 130 and a control section 100. The image processing section 133 processes image signals output from the camera module 140 in frames. Also, the image processing section 133 adjusts the frame image data to conform to the features, such as size and resolution, which are displayable on a display screen 135, and outputs the adjusted frame image data. The image processing section 133 comprises an image codec, and compresses the frame image data displayed on the display screen 135 in a preset manner or restores the compressed frame image data to the original frame image data. The image codec can be selected from JPEG codec, MPEG4 codec, or Wavelet codec. The image processing section 133 has an OSD (on screen display) function. The image processing section 133 can output image data in combination with OSD data under the control of the control section 100.

The display screen 135 displays image data output from the image processing section 133. The display screen 135 is divided into an image display area 137 for displaying an image and operational information of the mobile terminal and a state display area 139 for displaying the operational state of the mobile terminal.

The storing section 140 stores programs 142 for controlling general operations of the mobile terminal, images 144 photographed through the camera module 130 or input from outside, and a file list 146 of the images 144.

An image editing section 150 adjusts the sizes of the images 144 stored in the storing section 140.

A key input section 160 includes, for example, a send key 161, a photo key 162, an edit key 163, a store key 164, a size setting key 165, and a move key 166. The send key 161 is used to answer an incoming call or initiate a new call after dialing a phone number. The photo key 162 is used to input a command to photograph using the camera module 130. The edit key 163 is used to input a command to edit, such as a size adjustment, an image displayed on the display screen 135. Additionally, the edit key 163 can be composed of a plurality of keys needed to edit an image.

The store key 164 is pressed to input a command to store an image displayed on the display screen 135. The size setting key 165 is pressed to input a size in which a selected image should be stored. The move key 166 is used to move a cursor displayed on the display screen 135.

When the edit key 163 is pressed, inputting a command to edit an image, the control section 100 displays a list 146 of image files 144 stored in the storing section 140 on the image display area 137 or state display area 139 of the display screen 135 through the image processing section 133.

When a particular button included in the edit key 163 is pressed to input a command to preview, the control section 100 detects out the images 144 corresponding to the displayed image file list 146 from the storing section 140 and displays the detected images 144 on the image display area 137 of the display screen 135 through the image processing section 133.

If a particular button included in the edit key 163 is pressed to input a command to display a whole image during the sequential display of the images 144, the control section 100 displays in whole the image displayed when the command is input on the state display area 139. Also, the control section 100 displays a browsing cursor movable over a predetermined area of the whole image displayed on the state display area 139. The control section 100 enlarges a portion confined by the rectangular outline of the browsing cursor and displays the enlarged partial image on the image display area 137. The browsing cursor has a size sufficient to select a portion of an image that can be displayed on the image display area 137 at its original image quality.

When the move key 166 is pressed, inputting a command to move, the control section 100 moves the browsing cursor in a direction according to the command. At the same time, the control section 100 enlarges each portion confined by the browsing cursor and displays the enlarged partial image on the image display area 137.

When the store key 164 is pressed, inputting a command to store, the control section 100 edits the partial image confined by the browsing cursor through the image editing section 150 and stores the edited image as a new image in the storing section 140. At this time, the control section 100 can display an input window on the display screen 135 so that the user can input a desired size of the image to be stored. When a size is input using the size setting key 165, the control section 100 controls the image editing section 150 to adjust the image to be stored to the input size. The control section 100 stores the image of the size adjusted by the image editing section 150 as a new image in the storing section 140.

When a signal to set the edited image as wallpaper on the mobile terminal is input, the control section 100 displays the edited image as wallpaper on the image display area 137.

To summarize, the mobile terminal according to the present invention displays a whole image and a browsing cursor movable over a predetermined area of the whole image. When the browsing cursor is placed over a particular portion of the displayed image, that portion is enlarged and displayed at its original image quality.

Further, the partial image confined by the browsing cursor can be stored in an adjusted size. Therefore, it is possible to reduce the load of the mobile terminal during operations, such as wallpaper image display and data transmission using a communication network.

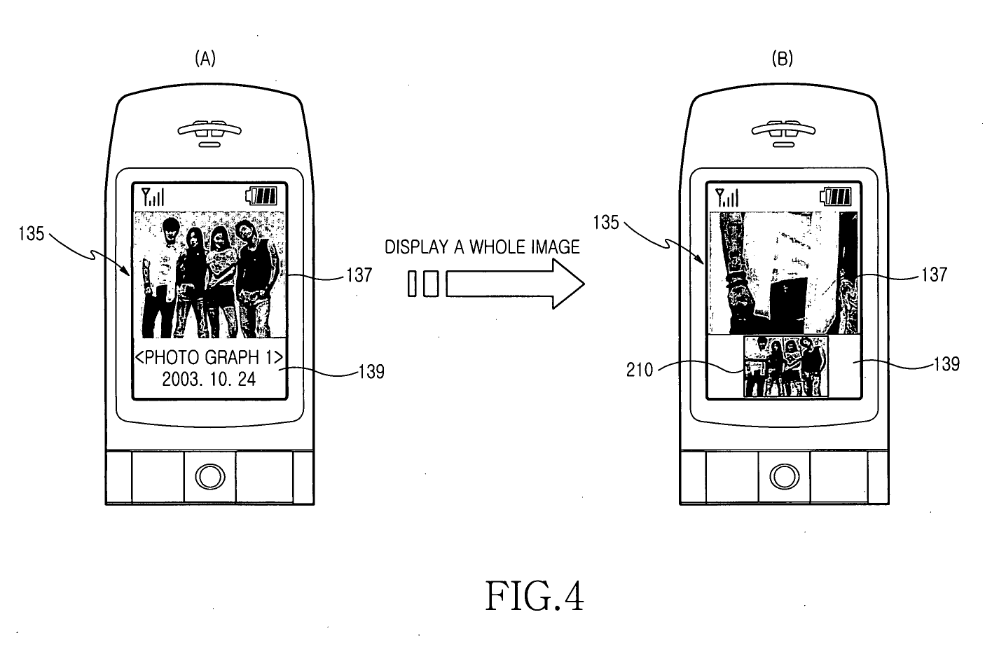

FIG. 4 illustrates a change of an image displayed on the mobile terminal in FIG. 3 when a command to display the whole image is input. When a command to preview is input from the key input section 160, the control section 100 displays an image stored in the storing section 140 on the image display area 137 of the display screen 135 as illustrated in (A) of FIG. 4. Also, the control section 100 displays the list number and storage information of the displayed image.

When a command to display the whole image is input from the key input section 160, the control section 100 displays the same image in whole on the state display area 139 as shown in (B) of FIG. 4. Additionally, the control section 100 displays the browsing cursor 210 that can be moved over a predetermined area of the whole image displayed on the state display area 139. The control section 100 enlarges the portion confined by the browsing cursor 210 and displays the enlarged partial image on the image display area 137.

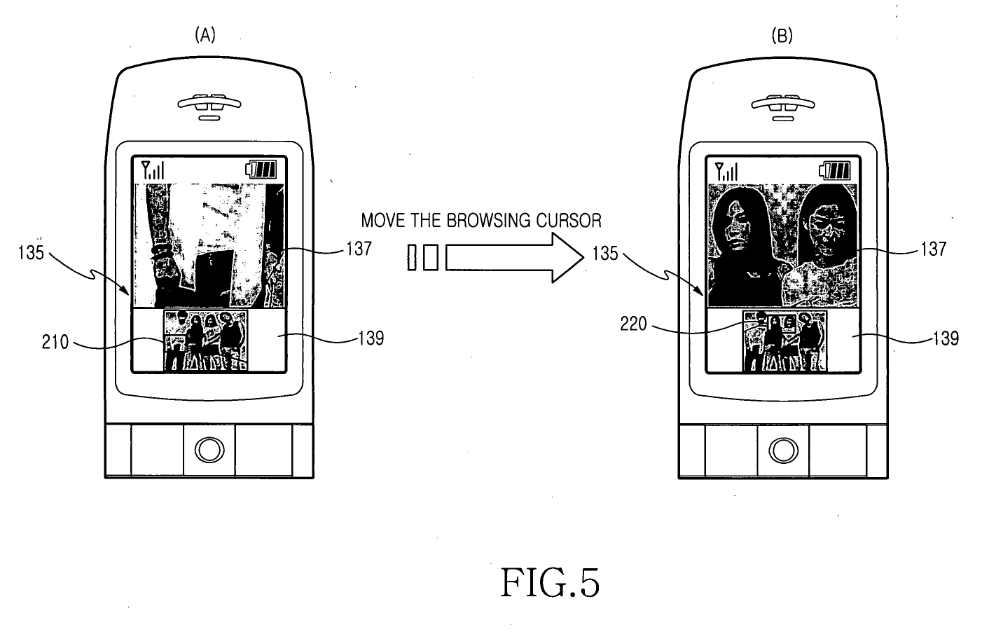

FIG. 5 illustrates a change of an image displayed on the display screen 135 according to the movement of the browsing cursor 210 in FIG. 4. As illustrated in FIG. 5 at (A), the whole image and the browsing cursor 210 movable over a predetermined area of the whole image are displayed on the state display area 139. However, a partial image confined by the browsing cursor 210 is displayed on the image display area 137.

When a command to move the browsing cursor 210 is input from the key input section 160, the control section 100 moves the browsing cursor 210 in a direction according to the input command and displays the moving browsing cursor 210 on the state display area 139. As illustrated in FIG. 5 at (B), the control section 100 displays the browsing cursor 220 moved and placed over a particular portion of the image displayed on the state display area 139. The control section 100 enlarges the partial image confined by the browsing cursor 220 and displays the enlarged image on the image display area 137. Therefore, the user can enlarge and display a particular portion of an image on the mobile terminal.

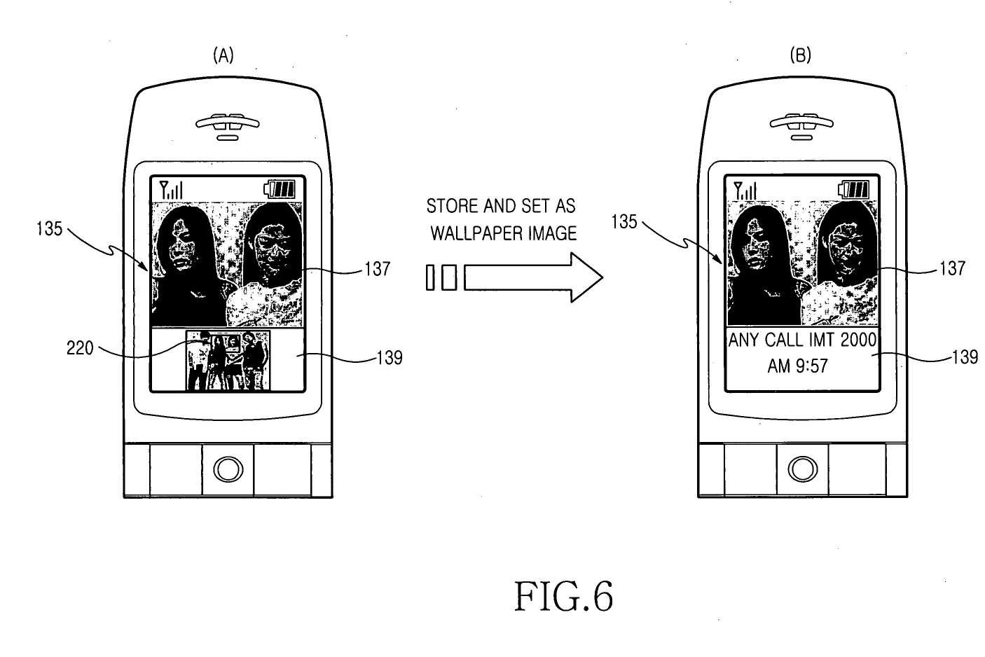

FIG. 6 illustrates a change of an image selected using the browsing cursor and displayed as a wallpaper image of the mobile terminal. When a command to save is input from the key input section 160, the control section 100 stores the partial image selected by the browsing cursor 220 and displayed on the image display area 137 as illustrates in FIG. 6 at (A) in the storing section 140. The control section 100 can display an input window on the display screen 135 to enable the size adjustment for the image to be stored. When a desired size is input, the control section 100 controls the image editing section 150 to adjust the image to the input size. Accordingly, the control section 100 stores the image in the size adjusted by the image editing section 150.

When a command to set the edited image as wallpaper is input, the control section 100 sets the image displayed and stored in FIG. 6 at (A) as wallpaper on the mobile terminal and displays the same image as the wallpaper image on the image display area 137 as illustrated in FIG. 6 as (B). The control section 100 displays the general information about the operation of the mobile terminal on the state display area 139. Therefore, according to the present invention, a particular portion of an image can be separately stored or set as a wallpaper image. Accordingly, it is possible to easily edit and use an image for various purposes within the mobile terminal.

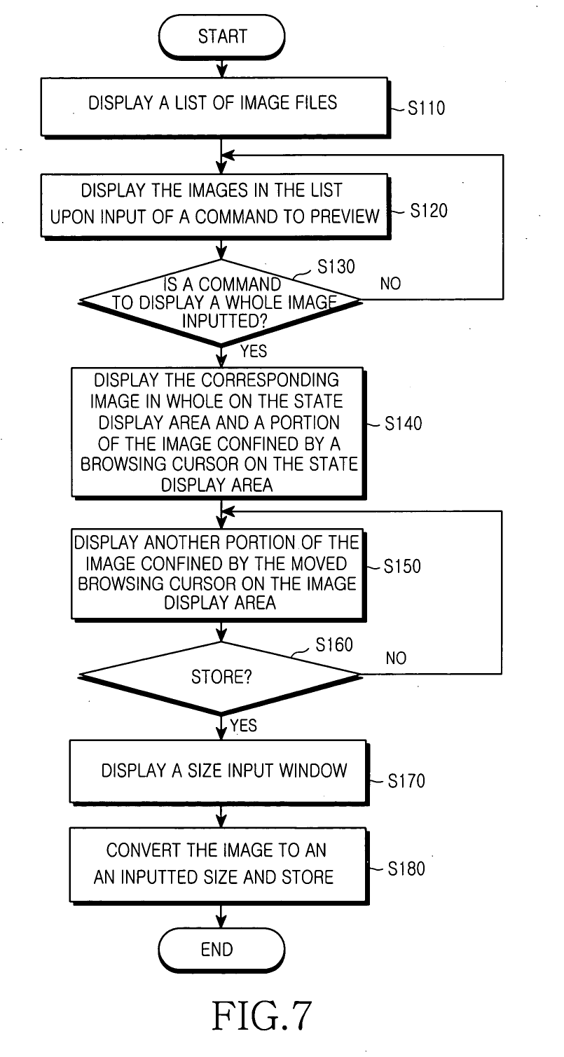

FIG. 7 is a flow chart illustrating a process of editing an image using a mobile terminal according to the preferred embodiment of the present invention. When a command to edit an image is input from the key input section 160, the control section 100 displays a list 146 of image files 144 stored in the storing section 140 on the display screen 135 in step S110. When a command to preview is input from the key input section 160, the control section 100 displays the whole images corresponding to the displayed list 146.

Upon determining the input of such a command, the control section 100 displays in whole the image displayed when the command is input on the state display area 139. Additionally, the control section 100 displays the browsing cursor 210 (FIG. 4) movable over a predetermined area of the whole image displayed on the state display area 139 in step S140. The control section 100 enlarges a portion confined by the rectangular outline of the browsing cursor 210 and displays the enlarged partial image on the image display area 137.

When the browsing cursor 21 is moved to confine another portion of the image, the control section 100 enlarges the other portion confined by the moved browsing cursor 220 and displays the enlarged partial image on the image display area 137 in step S150.

In step S160, the control section 100 determines whether a command to store is input while the partial image confined by the browsing cursor 220 is displayed on the image display area 137. Upon determination of the input of such a command, the control section 100 stores the partial image confined by the browsing cursor 220 in the storing section 140. The control section 100 can display an input window on the display screen 135 so that the user can input a desired size in which the image displayed on the image display area 137 should be stored in step S170.

When size information is input in the input window, the control section 100 controls the image editing section 150 to convert the partial image confined by the browsing cursor 220 to the input size. The control section 100 stores the image in the size adjusted by the image editing section 150 as a new image in the storing section 140 in step S180.

Preferably, when displaying the whole image and the partial image confined by the browsing cursor 220, the control section 100 should additionally display the sizes of the whole image and the partial image respectively on the two display areas 139 and 137.

Although it has been explained above that images larger than the image display area 137 of the mobile terminal can be adjusted in size or otherwise edited, the present invention is equally applicable to edit images smaller than the image display area 137. Also, the size of a browsing cursor can be adjusted to select a variety of image portions. The selected image portions can be displayed and stored at improved image quality. Further, the mobile terminal could have only an image display area on the display screen, without providing a state display area.

According to the present invention, the mobile terminal displays a whole image and a browsing cursor movable over a predetermined area of the whole image. When the browsing cursor is placed over a particular portion of the whole image, the portion is enlarged and displayed at its original image quality. The partial image can be separately stored and selected to be edited.

Additionally, the partial image confined by the browsing cursor can be stored in a size adjusted. In other words, any image portions to be stored can be edited in size. Therefore, it is possible to reduce the load of the mobile terminal during operations, such as wallpaper image display and data transmission using a communication network.

Although preferred embodiments of the present invention have been described for illustrative purposes, those skilled in the art will appreciate that various modifications, additions and substitutions are possible, without departing from the scope and spirit of the present invention as disclosed in the accompanying claims, including the full scope of equivalents thereof.

1. A mobile terminal including an image display area and a state display area, said terminal comprising:
a storing section for storing at least one image and a list of the at least one image;
an image editing section for editing the at least one image; and
a control section for displaying the at least one image in whole on the state display area and a browsing curser movable over a predetermined area of the at least one image displayed on the state display area, and enlarging a portion confined by the browsing cursor to display the portion on the image display area.

2. The mobile terminal according to claim 1, wherein said control section displays the list of the at least one image stored in the storing section on the image display area when a command to edit an image is input.

3. The mobile terminal according to claim 1, wherein control section additionally displays sizes of the whole image and the portion confined by the browsing cursor on the image display area and the state display, respectively, when displaying the whole image and the partial image.

4. The mobile communication terminal according to claim 1, wherein said control section displays an input window on a predetermined display area, upon input of a command to store, so that a user can input a size in which the image displayed on the image display area should be stored, and stores the image in the size input in the input window.

5. The mobile terminal according to claim 1, wherein said control section converts the portion displayed on the image display area to a desired size using the image editing section and stores the portion of the image in the storing section.

6. A method for editing an image using a mobile terminal including a display screen having an image display area and a state display area, said method comprising the steps of:
receiving a command to edit an image;
displaying the image in whole on the state display area;
displaying a browsing curser movable over a predetermined area of the image displayed on the state display area; and
enlarging a portion confined by the browsing cursor to display the portion on the image display area.

7. The method according to claim 6, further comprising the step of displaying sizes of the whole image and the selected portion on the image display area and the state display, respectively.

8. The method according to claim 6, further comprising the steps of:
receiving a command to store the partial image;
displaying an input window on the display area to enable a user to input a size in which the partial image displayed on the image display area should be stored;
receiving the size input; and
storing the partial image in the input size.

9. The method according to claim 6, further comprising the steps of:
receiving a command to store the portion displayed on the image display area; and
storing the portion displayed on the image display area.

10. A mobile terminal comprising:
a storing section for storing at least one image and a list of the at least one stored image;
an image editing section for editing the at least one image; and
a control section for displaying of the at least one stored image on a display area and a browsing curser that is movable over a predetermined area of the image displayed on the display area.

11. The mobile terminal according to claim 10, wherein said control section converts a portion confined by the browsing cursor to a desired size using the image editing section and stores the portion of the image in the storing section.

12. A method for editing an image using a mobile terminal, comprising the steps of:
receiving a command to edit an image;
displaying the image on a display area; and
displaying a browsing curser that is movable over a predetermined area of the image displayed on the display area.

13. The method according to claim 12, further comprising the steps of:
receiving a command to store a portion confined by the browsing cursor;
converting the portion confined by the browsing cursor and displayed on an image display area to a desired size using the image editing section; and
storing the portion displayed on the image display area.
